(19) United States
(12) Patent Application Publication
(10) Pub. No.: US 2015/0207400 A1
(43) Pub. Date: Jul. 23, 2015

(54) CONTROL APPARATUS AND METHOD FOR THERMAL BALANCING IN MULTIPHASE DC-DC CONVERTERS

(71) Applicant: Texas Instruments Incorporated, Dallas, TX (US)

(72) Inventors: Pradeep S. Shenoy, Richardson, TX (US); Michael DiRenzo, Coppell, TX (US)

(73) Assignee: Texas Instruments Incorporated, Dallas, TX (US)

(21) Appl. No.: 14/159,638

(22) Filed: Jan. 21, 2014

(51) Int. Cl. H02M 1/32; H02M 3/158

(52) U.S. Cl. CPC H02M 1/32; H02M 3/1584; H02M 2001/327

(57) ABSTRACT

Integrated circuit apparatus and processes are presented for controlling a plurality of parallel-connected DC-DC converter phases forming a multiphase DC-DC conversion system in which individual converter phases are successively activated or deactivated for increasing and decreasing load conditions, respectively, according to an ordered phase sequence, and the phase sequence is selectively modified to promote thermal balancing of the DC-DC converter phases.

### FIELD OF THE INVENTION

The present disclosure relates to multiphase DC-DC converters having multiple converter stages or phases providing a single DC output to drive a load.

### BACKGROUND

DC-DC converters come in many different forms, and include switches that are selectively actuated to provide a controlled DC output voltage or current based on a received DC input, where the pulse width or on time of the signaling provided to the converter switches is controlled to regulate the output power. A variety of pulse width modulation (PWM) techniques may be utilized to operate the DC-DC converter switches, including fixed frequency operation with adjustment to the duty cycle of the switching control signals, constant on time (COT) approaches to regulate the converter output by adjusting the so-called “off time” between pulses of a steady “on time”, as well as variable frequency control techniques using a constant duty cycle, etc. Multistage or multiphase conversion systems employ two or more DC-DC converter stages or phases with individual outputs connected in parallel to individually contribute to the output current of the system, and the outputs of the individual stages are typically connected to the system output via a corresponding output inductor. Such multiphase DC-DC converters are typically operated by activating or deactivating (e.g., adding or dropping) individual converter phases according to load conditions, with more phases being activated for higher load conditions and vice versa. However, system efficiency can be adversely affected by mismatching or parameter variation between the switches and/or the output inductors or other components of the individual power converter phases. Accordingly, there is a continuing need for improved multiphase DC-DC converter systems as well as control apparatus and techniques for improved power conversion system efficiency.

### SUMMARY

Multiphase DC-DC conversion system control apparatus and operating methods are presented, including integrated circuit DC-DC converter controllers by which improved system efficiency is promoted through managing activation and deactivation of the converter phases to more evenly share a thermal load. The inventors have appreciated that conventional DC-DC converter phase activation and deactivation according to a fixed schedule may lead to or exacerbate temperature-based variation in phase parameter values, such as the on resistance (e.g., Rdson) of the converter phase switch or switches and/or inductor impedance, even if the activated phases are controlled so as to balance the output current contributions through an active current sharing loop. Moreover, the inventors have appreciated that the most efficient operating point for the individual phases often does not coincide with operating levels when phase current contributions are balanced due to parameter variation, and hence regulating the activated converter phases to equally share the current load may not achieve optimal efficiency. In addition, attempts to maximize individual phase efficiency through non-uniform load sharing do not address the causes of the underlying parameter variation issue, and introduce unnecessary complexity in operation of a multiphase conversion system. The inventors have further appreciated that conventional phase activation/deactivation sequencing commonly leads to one phase (the “base” phase) being active at all times while other phases are only activated for a fraction of the time as needed according to varying load demand. As a result, the overall on-time of the base phase will be significantly longer than that of the other phases, and the base phase is likely to be operating at a higher temperature than a phase that has been off for some time and has had an opportunity to cool. In this regard, the inventors have appreciated that the phase(s) operating at a higher temperature will have higher resistance in the conduction path, thereby incurring higher power loss and lower efficiency using conventional fixed activation/deactivation sequencing techniques.

The present disclosure presents integrated circuits providing multiphase DC-DC converter system control as well as controller operating methods in which the phase activation/deactivation sequence is selectively modified, thereby promoting thermal balancing among individual phases. The various aspects of the disclosure can be employed in connection with a variety of multiphase control approaches, including those utilizing active current sharing loops to promote uniformity in the current outputs of the activated phases, as well control schemes in which non-uniform load sharing is implemented. Moreover, the presently disclosed thermal balancing techniques may be advantageously employed to reduce the variation in the phases proactively by managing the phase activation and deactivation such that the thermal load is more evenly shared among the phases.

One or more aspects of the present disclosure relate to integrated circuits, such as controller chips for controlling multiphase DC-DC conversion systems, including a control circuit which provides control signals or values to individual DC-DC converter phases according to a phase sequence defining successive activation and deactivation of the individual converter phases, as well as a thermal balancing circuit which selectively modifies the phase sequence to facilitate thermal balancing of the converter phases. The control circuit and thermal balancing circuit can be implemented using any suitable analog circuitry, logic circuits, programmable logic, processor circuitry program with suitable firmware/software, etc., and the integrated circuit may provide any suitable form of control signals or values to operate activated converter phases, whether setpoint signals provided to external pulse width modulation circuitry, or the integrated circuit may include internal PWM circuitry to provide PWM signals directly to switch on-board or external driver circuits, etc.

The selective activation/deactivation sequence modification may be triggered or initiated in a variety of techniques and circumstances. In certain embodiments, for example, the thermal balancing circuit may employ counters or timers or other suitable means by which the phase sequence is modified periodically or according to a schedule. In various embodiments, moreover, the thermal balancing circuit modifies the phase sequence in response to a predefined load or phase transition, for example, such as when the number of activated phases transitions between one and two. In other possible embodiments, the thermal balancing circuit modifies the phase sequence based at least partially on sensed or inferred phase operating temperatures, for example, such as when one or more DC-DC converter phase operating temperatures exceeds a threshold.

Moreover, the phase sequence modification may be of a variety of different forms in various implementations. In certain embodiments, the thermal balancing circuit rotates the phase sequence, for example, such that the “base phase” is no longer on all of the time. In other implementations, the thermal balancing circuit modifies the phase sequence in random fashion, or may modify the sequence to promote balancing of the on-times of the converter phases. In certain implementations, moreover, the balancing circuit may modify the phase sequence at least in part according to temperature signals or values representing the individual phase operating temperatures to facilitate balancing of the converter phase temperatures.

Further aspects of the present disclosure involve methods for multiphase DC-DC conversion system operation, including providing control signals or values to individually operate DC-DC converter phases, selectively successively activating individual converter phases for increasing load conditions according to a phase sequence, selectively successively deactivating individual converter phases for decreasing load conditions according to the phase sequence, as well as selectively modifying the phase sequence to facilitate thermal balancing of the converter phases.

### DESCRIPTION OF THE VIEWS OF THE DRAWINGS

The following description and drawings set forth certain illustrative implementations of the disclosure in detail, which are indicative of several exemplary ways in which the various principles of the disclosure may be carried out. The illustrated examples, however, are not exhaustive of the many possible embodiments of the disclosure. Other objects, advantages and novel features of the disclosure will be set forth in the following detailed description when considered in conjunction with the drawings, in which:

FIG. 1 is a schematic diagram illustrating a multiphase DC-DC conversion system having a plurality of DC-DC converter stages or phases connected in parallel to provide an output to drive a load according to control signals from a controller integrated circuit (IC) with a thermal balancing component or circuit configured to selectively modify the phase activation sequence in accordance with one or more aspects of the present disclosure;

FIG. 2 is a detailed schematic diagram illustrating an exemplary processor or logic-based implementation of the controller IC of FIG. 1;

FIG. 3 is a flow diagram illustrating an exemplary method for operating the multiphase DC-DC converter of FIG. 1 to provide thermal balancing through rotation of a phase activation sequence based on a timer or counter;

FIG. 4 is a graph showing exemplary DC-DC converter phase output currents provided by operation of the multiphase system of FIG. 1 according to an example output load profile using the timer-based phase activation sequence rotation method of FIG. 3 with the individual DC-DC converter phases being activated as needed according to the phase activation sequence to provide substantially equal phase output currents;

FIG. 5 is a graph showing another implementation of the output currents in the multiphase system of FIG. 1 using timer-based phase activation sequence rotation via the method of FIG. 3 in which the most recently activated converter phase may not provide the same output current as other activated phases;

FIG. 6 is a flow diagram illustrating another method for operating the multiphase DC-DC converter including thermal balancing by rotating the phase activation sequence in response to a predefined load or phase transition;

FIG. 7 is a graph illustrating exemplary DC-DC converter phase output currents using the activation sequence rotation method of FIG. 5; and

FIG. 8 is a flow diagram illustrating another method for operating the multiphase DC-DC converter including thermal balancing by modification of the phase sequence in response to one or more DC-DC converter phases exceeding a threshold temperature.

### DETAILED DESCRIPTION

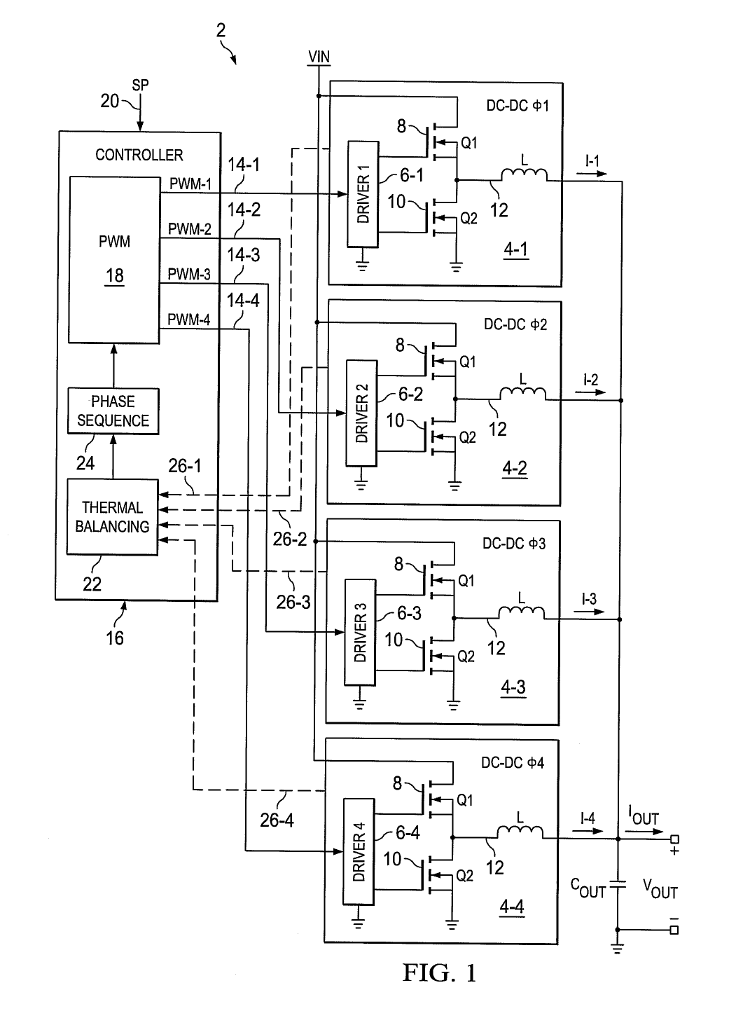

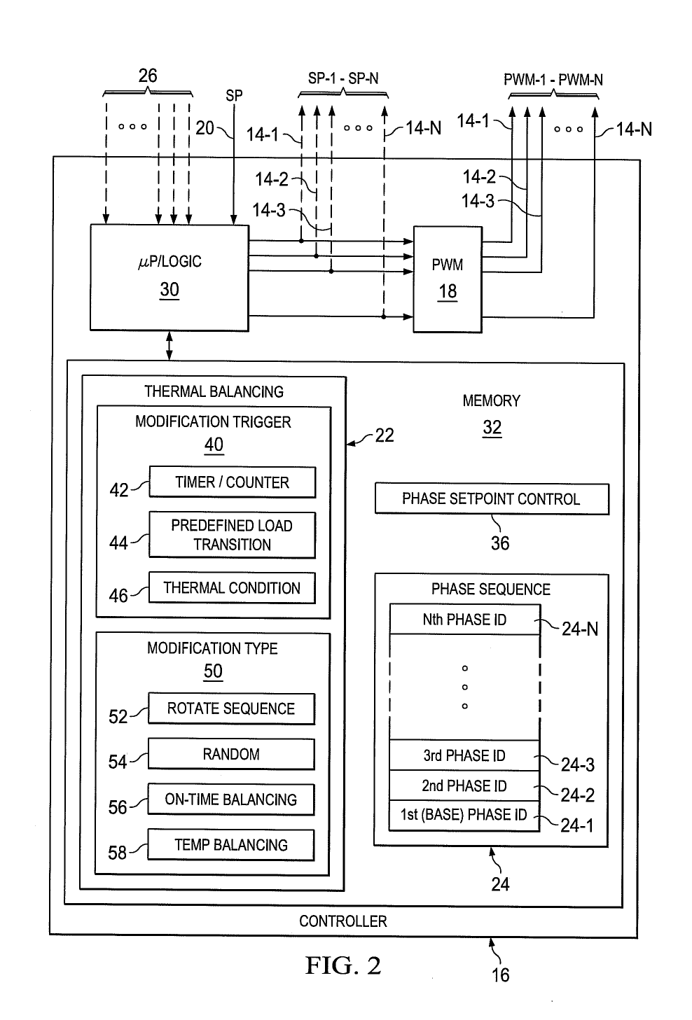

One or more embodiments or implementations are hereinafter described in conjunction with the drawings, wherein like reference numerals are used to refer to like elements throughout, and wherein the various features are not necessarily drawn to scale. The present disclosure provides intelligent management of the sequencing of converter phases in a multiphase DC-DC converter to promote more even thermal load sharing. FIGS. 1 and 2 illustrate an exemplary multiphase power conversion system 2 with a set of four DC-DC converter phases 4-1, 4-2, 4-3 and 4-4 (respectively labeled “DC-DC φ1”, “DC-DC φ2”, “DC-DC φ3” and “DC-DC φ4”), and a controller 16 providing pulse width modulated (PWM) control signals 14-1, 14-2, 14-3 and 14-4 to the individual converter phases 4. As illustrated, moreover, the outputs of the individual DC-DC converter phases 4 are connected to one another such that the output currents I-1, I-2, I-3 and I-4 additively contribute to provide a system output voltage V_{OUT} across an optional output capacitor C_{OUT} to provide an output current T_{OUT} to drive a single connected load (not shown). Although the exemplary system 2 is shown having four stages or phases 4, the concepts of the present disclosure find utility in connection with operation of multiphase DC-DC converter systems having any integer number N stages or phases, where N is greater than or equal to 2.

The illustrated DC-DC converter phases 4-1 through 4-4 in FIG. 1 are so-called “buck” type converters having upper and lower field effect transistor (FET) switches Q1 and Q2, respectively, controlled by a corresponding driver circuit 6-1, 6-2, 6-3 and 6-4 which provides corresponding upper and lower pulse width modulated switching control signals 8 and 10, respectively according to the PWM input control signals 14-1, 14-2, 14-3 and 14-4 from the controller 16. The upper and lower transistors Q1 and Q2 of each individual converter phase 4 are connected in series with one another between an input voltage VIN and a circuit ground, and are joined to one another at an internal node 12 that is connected to the positive system output terminal via a corresponding inductor L as shown. Buck converter operation is well known, with the driver 6 providing the control signals 8, 10 in inverse relationship to one another to generate the corresponding output currents I-1, I-2, I-3 and I-4 which together provide the overall system output, where the individual buck converters 4 may include other components which are not shown in the figures so as to avoid obscuring the thermal balancing control concepts of the present disclosure. Any suitable form of DC-DC converter phase architecture can be used, including without limitation buck converters, buck/boost converters, boost converters, cuk converters, or any other DC-DC conversion stage operative using one or more switching devices to convert DC power from the input VIN to provide a converter stage output. In one possible example, each individual buck DC-DC converter phase 4 may include only a single (e.g., upper) switching device Q1, with Q2 being replaced by a diode with a cathode connected to the internal node 12, and an anode connected to the circuit ground to form a buck converter, in which case the switching transistor Q1 may be operated generally in accordance with the PWM control signal 14 provided by the controller 16, with the driver circuitry 6 providing analog interfacing between the gate of the switching device Q1 and the signal output from the controller 16.

In the example of FIG. 1, the individual converter stages 4 may be individual integrated circuit products including the associated driver circuitry 6, the switches Q1, Q2 and the output inductor L, although other implementations are possible in which one or more of these components are provided separately, for example, a single driver integrated circuit 6 connected to separate switching devices Q1 and Q2 and an external output inductor L. The illustrated example, moreover, utilizes a separate controller integrated circuit 16 to provide pulse width modulated switching control signals 14 to the group of drivers 6, although other embodiments are possible in which a single controller integrated circuit 16 includes associated drivers 6 and possibly further components of the individual DC-DC converter stages 4 in a single integrated circuit product. For example, where the controller IC 16 includes on-board driver circuitry 6, the controller 16 in certain embodiments may provide upper and lower (inverse) PWM control signals 8, 10 to the individual upper and lower switches Q1 and Q2.

As shown in FIG. 1, the illustrated controller 16 includes a pulse width modulation (PWM) circuit or component 18, which generates pulse width modulated control signals 14 and provides these to the corresponding phase drivers 6. The PWM circuitry 18 may use any suitable form of pulse width modulation signal generation, including without limitation carrier-modulating PWM circuitry using a suitable periodic carrier waveform (e.g., a triangle waveform, a ramp sawtooth waveform, etc.) for modulating a setpoint signal voltage. In another possible alternate implementation, the individual DC-DC converter phases 4 may each include a pulse width modulation circuit 16, with the controller 16 providing analog setpoint signals or digital setpoint values 14-1, 14-2, . . . 14-N to the PWM circuitry 18 within the individual phases 4. In this regard, the various embodiments of the controller integrated circuit 16 are possible which provide any suitable type, number and form of control signals or values 14 to individually operate the DC-DC converter phases 4.

Moreover, the controller 16 may use any suitable means for activating and deactivating individual ones of the DC-DC converter phases 4. For example, in the embodiment of FIG. 1, the controller 16 may simply discontinue provision of a corresponding PWM output signal 14 to a given DC-DC converter phase 4, thereby deactivating that phase. Resumption of the corresponding PWM control signal 14 would then reactivate that phase. Other embodiments are possible, for instance, in which the controller 16 provides an analog setpoint signal or digital setpoint value to the individual phases 4, and a predetermined number (e.g., signal of 0 V or value of “zero” or some digital number representing an off condition) can be provided to the corresponding phase 4 to deactivate that phase, and provision of a different signal level or digital value to that phase would reactivate the phase. In other possible embodiments, a separate enable/disable signal or value or message could be provided by the controller 16 to the individual stages 4 for selective activation or deactivation thereof.

As seen in the exemplary buck converter multiphase system 2 of FIG. 1, the generation of the individual phase output currents I-1 . . . I-4 involves operation of many of electrical components, including the output inductor L, one or more switches Q1, Q2 and the driver circuitry 6. The inventors have appreciated that various constituent materials (e.g., copper, silicon, etc.) used in construction of the individual DC-DC converter phases 4 and the components thereof have temperature dependent values, such as the on-state resistance of the switches Q1, Q2, the impedance of the output inductor L, etc. In particular, many components of the converter phases 4 have a positive temperature coefficient (PTC), by which resistance increases as the device temperature increases, wherein certain converter phase component values may vary by a significant amount (e.g., 40%) over a typical rated operating temperature range (e.g., 100° C.). Furthermore, the inventors have appreciated that such temperature dependent parameter variation can significantly impact the efficiency of the associated converter phase 4. For example, microprocessor voltage regulators or other multiphase DC-DC conversion systems 2 may have rated load current values in excess of 100 A (with phase currents of 25 A or more). Conventional control of such multiphase converters may employ current sensing techniques using negative temperature coefficient (NTC) resistors on each phase to compensate for the effects of thermal variation, but this approach complicates the overall system design, and may not adequately compensate for variances in the output inductance with temperature.

In accordance with one or more aspects of the present disclosure, multiphase operation is implemented through the provision of the switching control signals or values 14 from the controller 16 to the individual DC-DC converter phases 4, with the controller 16 successively activating and deactivating individual DC-DC converter phases 4 according to a phase sequence 24, and thermal load balancing is facilitated in the system 2 via a thermal balancing circuit or component 22 of the controller 16 selectively modifying the phase sequence 24.

In particular, the controller 16 receives a setpoint signal or value 20 (or the controller 16 may be configured to operate according to a constant setpoint) representing a desired overall output (I_{OUT} and/or V_{OUT} in FIG. 1) for the system 2, and the controller 16 in certain implementations activates one, some or all of the phases 4 such that the number of activated phases 4 is sufficient to provide the desired output current at any given time. In this manner, the PWM circuit 18 in FIG. 1 (or the processor/logic circuit 30 discussed below in connection with FIG. 2) selectively successively activates individual DC-DC converter phases 4 for increasing load conditions according to the phase sequence 24 and selectively successively deactivates individual DC-DC converter phases 4 for decreasing load conditions according to the phase sequence 24. The phase sequence 24 defines an ordered sequence for successive activation of the individual DC-DC converter phases 4, and can be any suitable circuitry and/or memory organization by which such an ordering is maintained and modified. Between activations and deactivations of individual phases 4, moreover, the controller 16 may optionally implement some form of output current balancing and/or closed loop feedback control for regulation of the individual phase output currents I-1, I-2 . . . I-N through minor adjustments to the control signals or values 14.

Referring also to FIG. 2, in certain embodiments, the controller 16 is implemented using one or more processors or logic circuits 30 operatively coupled to an associated electronic memory 32. In this example, the processor or logic circuit 30 receives the setpoint signal or value 20 (or is programmed with a fixed setpoint value) and provides setpoint control signals or values 14-1, 14-2, 14-3 . . . 14-N as analog or digital setpoint signals or values SP-1, SP-2 . . . SP-N directly to the converter phases 4-1, 4-2 . . . 4-N for local generation of corresponding pulse width modulated switching control signals, or the controller 16 may include an onboard pulse width modulation circuit 18 providing an integer number N PWM control signals 14-1, 14-2, 14-3 . . . 14-N to driver circuits 6 of the individual converter phases 4 as shown in FIG. 1. In the implementation of FIG. 2, moreover, the processor or logic 30 is programmed or otherwise configured to store and maintain the phase sequence 24 in the memory 32, including an integer number N phase identifiers (IDs) in an ordered list, wherein the first or base phase ID 24-1 indicates a base one of the plurality of DC-DC converter phases 4, and subsequent phase IDs 24-2, 24-3 . . . 24-N indicate a successive list of subsequent ones of the plurality of DC-DC converter phases 4. In operation, for very low output current load conditions, only the first or “base” phase 4 identified by the first identifier 24-1 will be activated by the controller 16, and a subsequent increase in the output load requirement (e.g., above that serviceable the base phase) results in activation of another one of the converter phases 4 indicated by the second ID 24-2. Further load increases beyond that serviceable by two of the converter phases 4 results in activation of yet another converter phase 4 specified by the third phase ID 24-3, and load increases beyond that serviceable by N-1 converter phases 4 results in activation of the last or final (N^{th}) converter phase 4. The phase sequence 24 is used in reverse order for deactivation of certain of the converter phases 4, with the converter phase 4 indicated by the N^{th} identifier 24-N being deactivated first, and the subsequent phases 4 being deactivated as needed, with the first or base phase 4 (indicated by the identifier 24-1) remaining on at all times.

As seen in FIG. 2, moreover, the memory 32 in the illustrated embodiment includes programming instructions for implementing a thermal balancing component or circuit 22, including one or more phase sequence modification trigger conditions or algorithms 40 and one or more phase sequence modification types or forms 50. In this regard, proper programming of the processor circuitry 30 (or fixed configuration of the logic circuitry 30) constitutes an exemplary thermal balancing circuit 22 as represented in FIG. 1, and storage of the phase sequence list 24 in the electronic memory 32 of FIG. 2 constitutes an embodiment of the phase sequence 24 represented in FIG. 1.

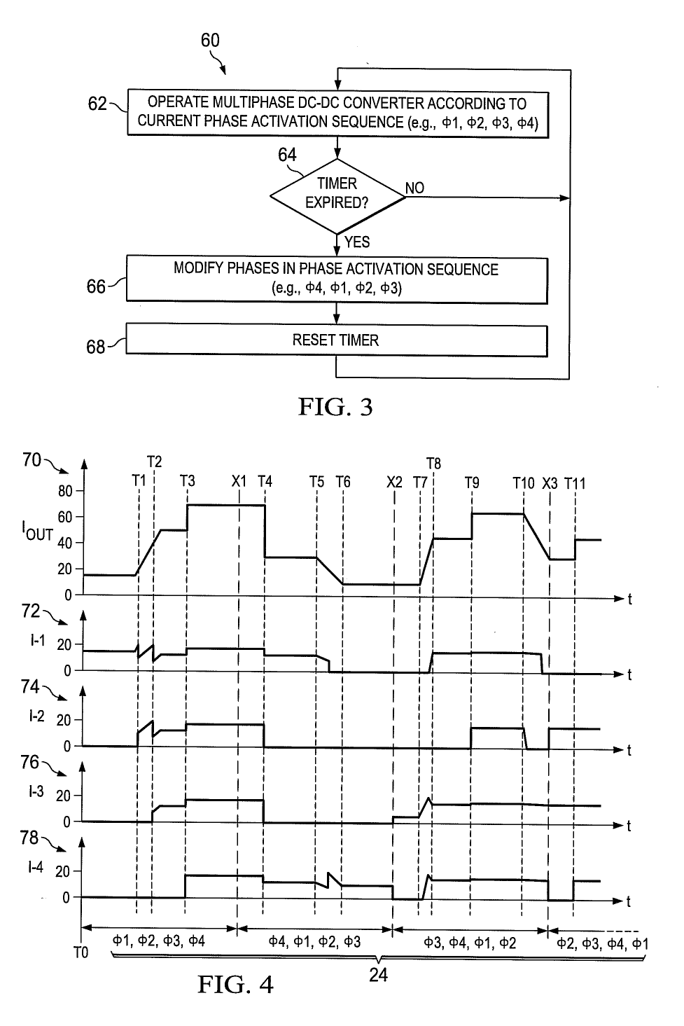

Referring also to FIGS. 3 and 4, in one possible embodiment, the thermal balancing circuit 22 (whether a fixed logic circuit implementation or a programmed processor implementation) selectively modifies the phase sequence 24 to promote thermal balancing of the converter phases 4 in operation of the multiphase system 2 in a periodic fashion. For example, as seen in FIG. 2, the controller 16 may implement a timer or counter 42 used as a phase sequence modification trigger. It is noted in this regard that the phase activation and deactivation operation may occur asynchronously to the timer/counter implementations of the phase sequence modification operation of the controller 16. This operation of the controller 16 is illustrated in a process 60 shown in FIG. 3, and FIG. 4 illustrates a graph 70 showing the overall system output load demand condition as a function of time along with graphs 72, 74, 76 and 78 respectively showing corresponding output currents I-1, I-2, I-3 and I-4 provided by the corresponding four DC-DC converter phases 4-1, 4-2, 4-3 and 4-4 in the four phase system 2 of FIG. 1. In the embodiment of FIG. 4, moreover, the individual DC-DC converter phases 4 are activated as needed according to the phase activation sequence 24 and the control signals or values 14 are provided to the phases 4 by the controller 16 so as to provide substantially equal phase output currents (current load sharing by activated converter phases 4), although not a strict requirement of all embodiments of the present disclosure.

In operation at 62 in FIG. 3, the controller 16 operates the system 2 according to the current phase activation sequence 24 currently stored in the electronic memory 32 of FIG. 2. In one example, the phase sequence 24 may begin with the first or base phase identifier 24-1 of FIG. 2 identifying the first converter phase 4-1, the second ID 24-2 identifying the second converter phase 4-2, the third phase ID 24-3 identifying the third converter phase 4-3, and the last phase ID 24-N identifying the fourth DC-DC converter phase 4-4. In this situation, the controller 16 operates at 62 by providing the output signals or values 14 to the corresponding activated phases 4 based on the desired operating point or setpoint signal or value 20 (FIG. 2) and any feedback signals or values if closed-loop operation is implemented, and also based on the activation/deactivation phase sequence 24, activating individual phases 4 as needed and deactivating individual phases 4 where possible in order to accommodate the desired output load condition.

The controller 16 determines at 64 in FIG. 3 whether the timer or counter 42 (FIG. 2) has expired. If not (NO at 64 in FIG. 3), the controller 16 continues the normal operation at 62. This is shown in the graphs 70-78 of FIG. 4, in which the controller 64 operates the phases 4 such that the base phase 4-1 satisfies the load condition from time T0 until time T1. In the example shown in FIG. 4, the individual converter phases 4 are each rated to provide 20 A of output current, with the entire four phase system 2 being rated for 80 A operation. In this example, moreover, the controller 16 activates the next listed converter phase 4 according to the sequence 24 once the current allocation of activated phase(s) have reached their rated output current and the demanded load condition requires more current. Other implementations are possible, for example, in which the controller 16 implement some form of hysteresis in the transitioning to activate or deactivate the phases 4. In the example of FIG. 2, the processor/logic 30 may be programmed with further algorithms or programming instructions 36 for phase setpoint control, by which the controller 16 determines the individual levels at which activated phases 4 are to be operated for providing the control signals or values 14, as well as the logic and particulars of the activation/deactivation operation (e.g., hysteresis, etc.).

As seen in FIG. 4, the controller 16 sees an increase in the setpoint signal or value 20 starting just prior to the time T1, and thus initially ramps the first phase 4 up to the rated (20 amp) level, and thereafter activates the next phase (phase 4-2) to add its output current I-2 to the overall system output, as seen in the graph 74 in FIG. 4. Between T1 and T2, the controller 16 ramps both the activated output phases up at generally equal levels until both have reached their rated values at time T2, whereupon the controller 16 activates the third phase 4-3 according to the phase sequence 24 stored in the memory 32. Since the demanded current in the graph 70 continues to increase after time T2, the controller 16 responds by ramping each of the activated phases 4-1, 4-2 and 4-3 upward through the provision of corresponding control signals or values 14-1, 14-2 and 14-3 until the demanded current reaches a plateau, with the controller 16 operating the three selected phases 4-1, 4-2 and 4-3 at essentially equal, constant values until time T3. At that point in the illustrated example, the demanded output current condition (graph 70) undergoes a step increase to a level requiring activation of the fourth phase 4-4, whereupon the controller 16 activates this phase to provide its contribution to the overall demanded output current as shown in graph 78.

Thereafter, the controller 16 continues to operate all four of the converter phases at substantially equal output currents by the provision of the corresponding control signals or values 14 until the timer or counter 42 expires (YES at 64 in FIG. 3), as indicated by X1 in FIG. 4. As shown in FIG. 4, the phase sequence 24 from time T0 through X1 is φ1, φ2, φ3, φ4. As shown in FIG. 3, in this embodiment, the thermal balancing component or circuit 22 implements phase sequence modification through rotation at 66 in FIG. 3 in response to expiration of the timer 42 (e.g., the microprocessor or logic 30 is programmed to implement a “ROTATE SEQUENCE” algorithm or logic 52 in FIG. 2). Thereafter, the controller 16 resets the timer at 68 in FIG. 3 and returns to operate the system 2 according to the current phase activation sequence 24 at 62. In one possible implementation shown in FIG. 4, for instance, the thermal balancing circuit 22 changes the sequence at 66 by rotating the four listed identifiers in the phase sequence 24, resulting in the first or phase identifier 24-1 indicating the fourth converter phase 4-4, followed by the first phase 4-1, the second phase 4-2 and finally the third phase 4-3 (φ4, φ1, φ2, φ3). As a result of this phase sequence modification at time X1, the controller 16 does not change any of the phase output currents in this example since all four phases 4 are activated and substantially equal output load current sharing is implemented.

Thereafter at time T4, however, the demanded output load condition undergoes a step change down to a level at which only two of the phases 4 are required, in which case the controller 16 deactivates the top two phases 4 indicated in the phase sequence listing 24 (deactivates phase 4-2 and phase 4-3 in this example), with the remaining activated phases 4-1 and 4-4 generally sharing the output load equally. The controller 16 continues this operation after time T5 with the output load demand ramping down from T5 to T6 to a level only requiring activation of one converter phase 4, and the controller 16 accordingly deactivates the phase 4-1 between T5 and T6 and provides the output current using the single remaining activated (e.g., “base”) converter phase 4-4 as shown in FIG. 4. It is noted at T6 in FIG. 4 that conventional operation using a fixed or static phase sequence 24 would have maintained the first stage 4-1 as the base phase continuously, and thus the temperature of that phase 4-1 would likely be higher than that of the remaining phases, whereas operation of the controller 16 using the thermal balancing circuit or component 22 according to various aspects of the present disclosure advantageously allows for deactivation of the first stage 4-1, thus allowing this stage 4-1 to cool. As a result, the parameter variation between the various phases 4 in the multiphase DC-DC converter system 2 is reduced as a result of the thermal load sharing between the phases 4.

At time X2 in FIG. 4, the thermal balancing timer/counter 42 to again expires (YES at 64 in FIG. 3), and the thermal balancing component or circuit 22 responds at 66 in FIG. 3 by again rotating the identifiers in the phase sequence listing 24 in the memory 32 (FIG. 2) and again resetting the timer at 68 in FIG. 3. At this point, the phase sequence 24 is now (φ3, φ4, φ1, φ2) as shown in FIG. 4, and the thermal balancing circuit 22 modifies the phase sequence 24 again after another expiration of the timer counter 42 at X3 in FIG. 4 to provide a further rotated phase sequence 24 (φ2, φ3, φ4, φ1). As further shown in FIG. 4, the controller 16 continues operation by selective activation of further phases 4 as needed to follow the demanded output current profile in graph 70, accommodating the illustrated ramped increase in the output current demand between time T7 and T8 (including resumed activation of phase 4-1 at T8). This is followed by a step increase in the demanded output current at T9 (leading to reactivation of the converter phase 4-2 at T9), and subsequent deactivation of phase 4-2 and then phase 4-1 between time T10 and time X3 in response to a decrease in the demanded current, with the next phase sequence modification at X3 resulting in deactivation of phase 4-4 at X3 and activation of phase 4-2, with phase 4-4 being again activated at time T11 to accommodate a step increase in the demanded output current. This operation continues with periodic phase sequence modification by the thermal balancing circuit 22 in conjunction with phase activation/deactivation by the controller 16 according to the then-current phase sequence 24.

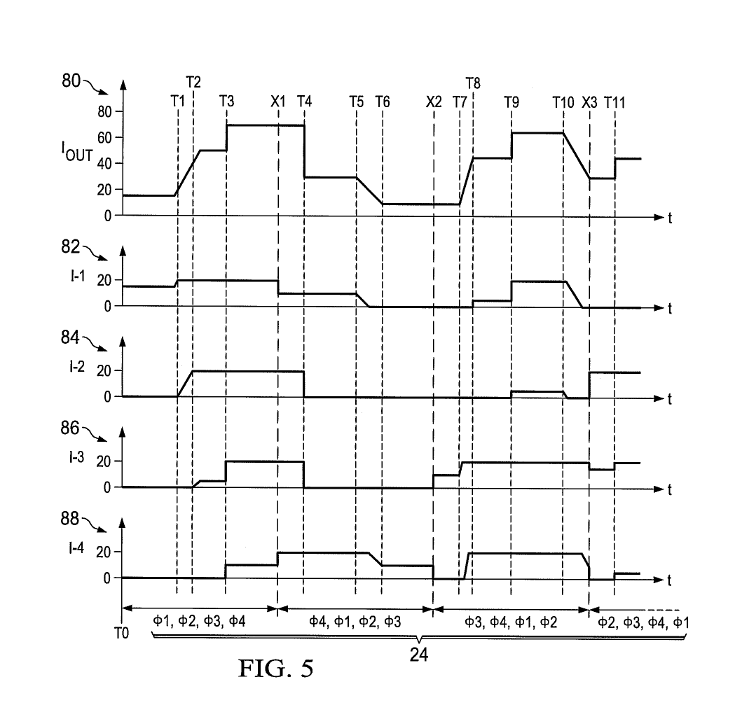

FIG. 5 illustrates another possible implementation using periodic phase sequence rotation as discussed above, with the controller 16 in this case instead implementing the control signals or values 14 provided to the individual converter stages 4 without using equal current sharing between activated phases 4. As seen in the demanded output load profile graph 80 and the four phase current graphs 82, 84, 86 and 88 in FIG. 5, for example, the controller 16 in this embodiment operates such that the most recently activated converter phase 4 does not provide the same output current as other activated phases. Rather, the controller 16 in this case operates any previously activated phase or phases 4 at its/their rated output and operates the most recently activated phase 4 at a level required to satisfy the further requirements of the demanded output current profile indicated by the setpoint signal or value 20. As in the above embodiment of FIG. 4, moreover, the implementation of FIG. 5 (without equal current sharing between activated phases 4) also advantageously rotates the phase sequence 24 in a periodic fashion, whereby the original base phase 4-1 is deactivated between T5 and T6, whereby the thermal load experienced by this phase 4-1, and hence the amount of temperature related parameter variation thereof, is reduced compared with conventional approaches in which a static or fixed phase sequence 24 is used.

The operation described above in connection with FIGS. 4 and 5 thus implements rotational type modification of the phase sequence 24 via the thermal balancing circuit 22. In this regard, while the illustrated rotation algorithm involves moving the previous “base” converter phase 4 from the first position to the second position, other rotational implementations are possible using the ROTATE SEQUENCE modification type algorithm 52 in FIG. 2. In one non-limiting example, for instance, the thermal balancing circuit 22 may rotate the listing of the sequence 24 in the opposite direction, e.g., by moving the previous “base” converter phase 4 from the first position to the last position, and moving the previous second position phase 4 to the first or “base” position, etc.

Other periodic types of phase sequence modification may be implemented in various embodiments by the thermal balancing circuit 22. For example, in certain embodiments, the thermal balancing circuit 22 is programmed or otherwise configured to periodically modify the phase sequence 24 in random fashion. In one possible implementation, the balancing circuit 22 may implement a random modification algorithm or logic 54 (FIG. 2) by which at least two of the identifiers 24-1, 24-2, 24-3 . . . 24-N are changed in the phase sequence 24, and the thermal balancing circuit 22 in this case may preferably ensure that the base or first identifier 24-1 is always changed in certain implementations.

In accordance with further aspects of the present disclosure, moreover, the thermal balancing circuit 22 may periodically modify the phase sequence 24 taking into account the on-times of the individual DC-DC converter phases 4. For instance, the thermal balancing component 22 may track the amount of time that each of the phases 4 is activated or “on”, and may implement an on-time balancing algorithm 56 (FIG. 2) by which a particular converter phase 4 having the highest amount of on-time within a certain monitoring period may be moved to the highest (least used) position 24-N in FIG. 2 at each phase sequence modification (e.g., in response to expiration of the counter/timer 42 (YES at 64 in FIG. 3)).

In further aspects of the present disclosure, the control circuit 30, 18 receives a temperature signal or value 26 corresponding to each of the converter phases 4 (e.g., signals 26-1, 26-2, 26-3, 26-4 in FIG. 1) from corresponding thermal sensing circuitry (e.g., thermistors, thermocouples, etc.) within or proximate to one or more components (e.g., switches Q1, Q2 and/or inductor L) of each of the individual phases 4 to indicate temperatures of the corresponding converter phases 4 or components thereof. The thermal balancing circuit 22 in such embodiments may thus implement a temperature balancing algorithm or logic 58 (FIG. 2) in periodic fashion (e.g., in response to expiration of a timer/counter 42). In one possible example, the thermal balancing circuit 22 may periodically modify two or more of the identifier positions in the phase sequence listing 24 in the memory 32 in order to move the identifier of the converter phase 4 associated with the highest sensed temperature to the least often used (top) position 24-N, thereby enhancing the opportunity for that phase 4 to cool, and may implement such temperature-driven inverse prioritization for more than one of the phases 4, for example, by ordering the phase sequence listing 24 such that the first (base) position 24-1 is occupied by the coolest phase 4, with subsequent positions being assigned to the converter phase 4 having the next coolest temperature, etc.

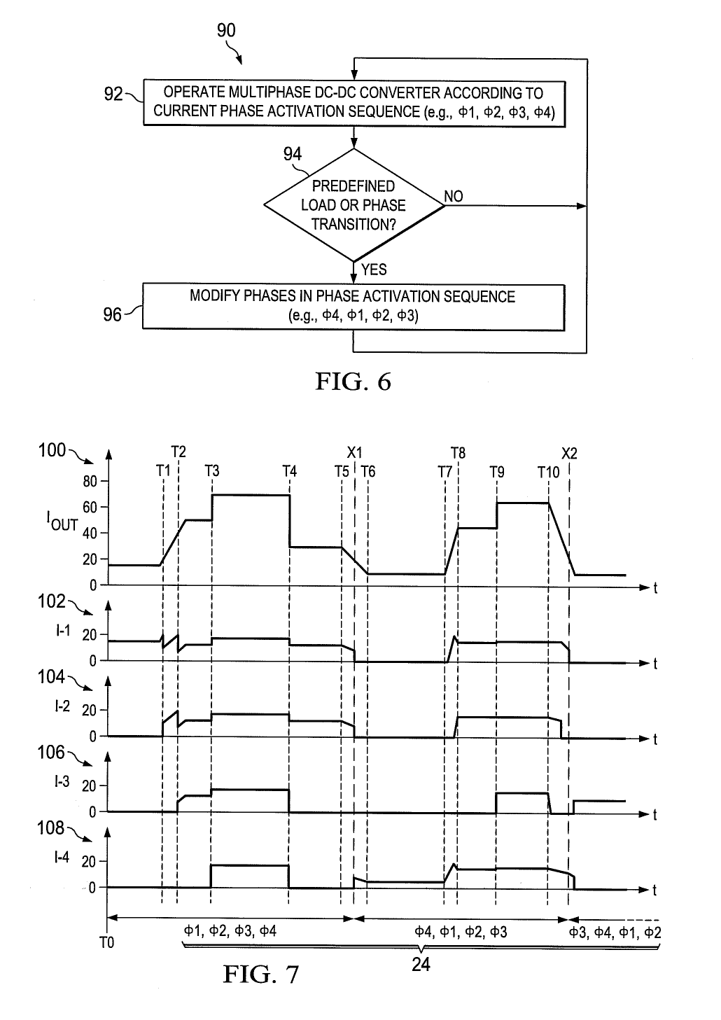

Referring now to FIGS. 1, 2, 6 and 7, the controller 16 may implement the process or method 90 of FIG. 6 in accordance with further aspects of the present disclosure with the thermal balancing circuit 22 modifying the phase sequence 24 in response to a predefined load or phase transition according to a predefined load or phase transition algorithm or logic 44 in FIG. 2. Unlike the example of FIG. 3 above, the process 90 in FIG. 6 does not employ a timer for phase sequence modification, and the modification of the phase sequence 24 may thus be faster in certain situations, or slower and other conditions, depending on the load profile indicated by the setpoint signal or value 20. At 92 in FIG. 6, the controller 16 operates the multiphase system 2 according to the current phase activation sequence 24 as described above, and determines at 94 whether a predefined load or phase transition has occurred. For example, the thermal balancing circuit 22 (e.g., implemented via the processor/logic 30 in FIG. 2) may monitor the output load profile shown in graph 100 of FIG. 7, and determine whether one or more predefined transitions have occurred in the demanded output current and/or whether one or more predefined transitions have occurred in the converter phase activation/deactivation operation implemented by the controller 16. Non-limiting examples of predefined load transitions include the demanded load transitioning below a fixed percentage of the overall rated system output, such as a transition below a threshold at which the phase activation/deactivation algorithm 36 calls for deactivation of all but one (e.g., the base) converter phase 4. In this manner, the thermal balancing circuit 22 may preferentially implement the phase sequence modification operation only at low or light load requirements, thereby ensuring that a phase 4 which was previously indicated as the “base” phase in the sequence listing 24 is expected to be allowed to cool for a time through deactivation resulting from reordering of the phase sequence 24. In other possible similar implementations, the thermal balancing circuit 22 may be programmed or otherwise configured to automatically perform a phase sequence modification each time the phase 4 associated with the second listing position 24-2 is to be deactivated.

In response to such a modification trigger condition 44 in FIG. 2, (YES at 94 in FIG. 6), the thermal balancing circuit 22 in certain embodiments can initiate any suitable form of phase sequence modification type 50 at 96 in FIG. 6 as described above, including without limitation phase sequence rotation logic 52 in FIG. 2, random phase sequence modification algorithm or logic 54, on-time balancing phase sequence modification logic or algorithms 56 and/or temperature balancing phase sequence modification algorithms 58. FIG. 7 further illustrates this concept of the present disclosure, in which the balancing circuit 22 operates using an initial phase sequence 24 (φ1, φ2, φ3, φ4), and then senses or otherwise detects a transition in the demanded output current (graph 100 and FIG. 7) downward from a level at T5 requiring use of two phases 4-1 and 4-2 to a point before time T6 at which only one of the phases (e.g., the base phase) is required to service the currently demanded output load. In response to this transition in the load and/or activated phases 4, the thermal balancing circuit 22 in this example rotates the phase activation sequence 24 at time X1, thereby deactivating the previous base phase 4-1, and activating the new base phase 4-4 as shown in the graphs 102, 104, 106 and 108 in FIG. 7. Thereafter, until another such predefined transition in the load and/or in the phase activation at time X2, the controller 16 operates according to the updated (e.g., rotated) phase sequence 24 (φ1, φ2, φ3), leading to a further rotational modification of the phase sequence listing 24. This load and/or phase transition triggering mechanism 44 may be implemented using any suitable modification types (e.g., 52, 54, 56 or 58 in FIG. 2) in further embodiments.

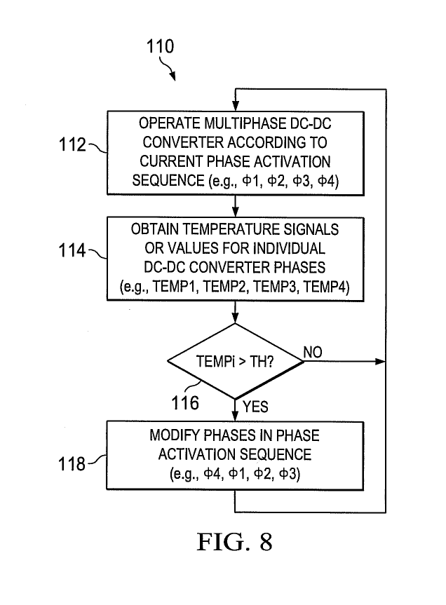

Referring also to FIG. 8, the controller 16 and the thermal balancing circuit 22 thereof may be operated according to another exemplary process 110 in FIG. 8, in order to perform selective phase sequence modification triggered by, or in response to, one or more thermal conditions in the system 2, for example, according to a thermal condition detection or determination algorithm or logic 46 (FIG. 2). At 112 in FIG. 8, the controller 16 operates the multiphase DC-DC conversion system 2 according to the current phase activation sequence 24, and obtains one or more temperature signals or values for the individual DC-DC converter phases 4 at 114. For example, the controller 16 may receive the temperature signals or values 26 at 114 in FIG. 8 from suitable sensors operatively associated with the converter phases 4 as shown in FIGS. 1 and 2 above.

A determination is made by the thermal balancing circuit 22 at 116 in FIG. 8 as to whether one or more of the temperature signals or values (TEMPi at 116) exceeds a predetermined threshold TH. If not (NO at 116), the process continues at 112 and 114 as described above. If, however, one or more of the phase temperatures exceeds the threshold (YES at 116), the thermal balancing circuit 22 modifies the phase activation sequence 24 at 118. As with the above described periodic or load/phase transition based sequence modification triggering approaches, the thermal condition-based phase sequence modification of FIG. 8 may be implemented using any suitable modification type 50 in FIG. 2, including without limitation rotation of the sequence 24, random sequence modification, on-time balancing phase sequence modification and/or temperature balancing type modification as previously described. Moreover, various embodiments are contemplated in which two or more sequence modification triggering conditions may be used and/or two or more modification techniques may be employed. For instance, the thermal balancing circuit 22 may be configured to modify the phase activation sequence 24 randomly and through rotation in a periodic fashion, by alternately performing a random modification and then a rotational modification, followed by a further random modification, etc. In other possible embodiments, the balancing circuit 22 can be configured to perform such periodic modification (random, or rotational, or combinations thereof) in addition to selectively modifying the phase activation sequence 24 by preferentially deactivating a particular DC-DC converter phase 4 for which the corresponding temperature signal or value 26 exceeds a threshold TH. In other non-limiting examples, the balancing circuit 22 may perform a rotational type sequence modification according to one type of triggering condition, perform a random sequence modification according to a second type of triggering condition (or conditions), and perform selective or preferential sequence modification according to another triggering condition (e.g., based on temperature signals or values, or on-time threshold determinations, etc.). Many other possible embodiments may be implemented using two or more modification techniques and/or modification triggering algorithms or logic.

As set forth above, the thermal balancing concepts of the present disclosure advantageously provide a simple mechanism by which the thermal load of a multiphase DC-DC conversion system 2 can be effectively balanced between a plurality of converter phases 4, and these concepts can be employed in systems 2 having any integer number N converter phases 4 (N≧2), and can be used in systems employing current balancing between activated phases 4, or in other systems that do not require equal currents among activated phases 4. This, in turn, facilitates more even distribution of the thermal load between the converter phases 4, and consequently less parameter variation between the converter phases 4. As a result, the various aspects of the present disclosure may be employed to facilitate improved system efficiency, reduction in thermal management overhead (e.g., less required heat sinking, or better utilization of existing heat sinking, etc.), simpler sensing/control/regulation of current (e.g., without requiring usage of PTC or NTC sensing circuit components), and longer lifetime/improved reliability of the system 2 and its component converter phases 4. Moreover, the techniques described in the present disclosure may be easily implemented in processor-based DC-DC converter control integrated circuits and other systems without significant hardware modification.

The above examples are merely illustrative of several possible embodiments of various aspects of the present disclosure, wherein equivalent alterations and/or modifications will occur to others skilled in the art upon reading and understanding this specification and the annexed drawings. In addition, although a particular feature of the disclosure may have been disclosed with respect to only one of multiple implementations, such feature may be combined with one or more other features of other embodiments as may be desired and advantageous for any given or particular application. Also, to the extent that the terms “including”, “includes”, “having”, “has”, “with”, or variants thereof are used in the detailed description and/or in the claims, such terms are intended to be inclusive in a manner similar to the term “comprising”.

What is claimed is:

1. An integrated circuit for controlling a multiphase DC-DC conversion system having a plurality of DC-DC converter phases with corresponding outputs connected to drive a load, the integrated circuit comprising:
a control circuit providing a plurality of control signals or values to individually operate one or more of the plurality of DC-DC converter phases to provide an output according to a phase sequence defining an ordered sequence for successive activation of the individual DC-DC converter phases for increasing load conditions or successive deactivation of the individual DC-DC converter phases for decreasing load conditions; and
a thermal balancing circuit operative to selectively modify the phase sequence to facilitate thermal balancing of the plurality of DC-DC converter phases.

2. The integrated circuit of claim 1, wherein the thermal balancing circuit is operative to modify the phase sequence periodically.

3. The integrated circuit of claim 2, wherein the thermal balancing circuit is operative to periodically modify the phase sequence by rotating the phase sequence.

4. The integrated circuit of claim 2, wherein the thermal balancing circuit is operative to periodically modify the phase sequence randomly.

5. The integrated circuit of claim 2, wherein the thermal balancing circuit is operative to periodically modify the phase sequence to facilitate balancing of on-times of the plurality of DC-DC converter phases.

6. The integrated circuit of claim 2, wherein the control circuit receives a plurality of temperature signals or values indicating temperatures of the plurality of DC-DC converter phases, and wherein the thermal balancing circuit is operative to periodically modify the phase sequence at least partially according to the temperature signals or values to facilitate balancing of the temperatures of the plurality of DC-DC converter phases.

7. The integrated circuit of claim 1, wherein the thermal balancing circuit is operative to modify the phase sequence in response to a predefined load or phase transition.

8. The integrated circuit of claim 7, wherein the thermal balancing circuit is operative to modify the phase sequence by rotating the phase sequence in response to the predefined load or phase transition.

9. The integrated circuit of claim 7, wherein the thermal balancing circuit is operative to modify the phase sequence randomly in response to the predefined load or phase transition.

10. The integrated circuit of claim 7, wherein the thermal balancing circuit is operative to modify the phase sequence to facilitate balancing of on-times of the plurality of DC-DC converter phases in response to the predefined load or phase transition.

11. The integrated circuit of claim 7, wherein the control circuit receives a plurality of temperature signals or values indicating temperatures of the plurality of DC-DC converter phases, and wherein the thermal balancing circuit is operative to modify the phase sequence at least partially according to the temperature signals or values to facilitate balancing of the temperatures of the plurality of DC-DC converter phases in response to the predefined load or phase transition.

12. The integrated circuit of claim 1, wherein the control circuit receives a plurality of temperature signals or values indicating temperatures of the plurality of DC-DC converter phases, and wherein the thermal balancing circuit is operative to modify the phase sequence in response to at least one of the temperature signals or values exceeding a threshold.

13. The integrated circuit of claim 12, wherein the thermal balancing circuit is operative to modify the phase sequence to preferentially deactivate at least one DC-DC converter phase having a corresponding temperature signal or value exceeding the threshold.

14. The integrated circuit of claim 12, wherein the thermal balancing circuit is operative to modify the phase sequence by rotating the phase sequence in response to at least one of the temperature signals or values exceeding the threshold.

15. The integrated circuit of claim 12, wherein the thermal balancing circuit is operative to modify the phase sequence to facilitate balancing of on-times of the plurality of DC-DC converter phases in response to at least one of the temperature signals or values exceeding the threshold.

16. The integrated circuit of claim 1, comprising a pulse width modulation (PWM) circuit (18) operative to provide the plurality of control signals as a plurality of pulse width modulated control signals to the plurality of DC-DC converter phases according to the phase sequence.

17. The integrated circuit of claim 1, comprising an electronic memory and at least one processing circuit programmed or configured to maintain the phase sequence in the electronic memory, and to selectively modify the phase sequence to facilitate thermal balancing of the plurality of DC-DC converter phases.

18. A method for operating a multiphase DC-DC conversion system having a plurality of DC-DC converter phases with corresponding outputs connected to drive a load, the method comprising:
providing a plurality of control signals or values to individually operate one or more of the plurality of DC-DC converter phases to provide an output;
selectively successively activating individual DC-DC converter phases for increasing load conditions according to a phase sequence;
selectively successively deactivating individual DC-DC converter phases for decreasing load conditions according to the phase sequence; and
selectively modifying the phase sequence to facilitate thermal balancing of the plurality of DC-DC converter phases.

19. The method of claim 18, comprising selectively modifying the phase sequence periodically, or in response to a predefined load or phase transition, or in response to a temperature of at least one of the DC-DC converter phases exceeding a threshold.

20. The method of claim 18, wherein selectively modifying the phase sequence comprises at least two of rotating the phase sequence, modifying the phase sequence randomly, modifying the phase sequence to facilitate balancing of on-times of the plurality of DC-DC converter phases, and modifying the phase sequence to preferentially deactivate at least one DC-DC converter phase having a corresponding temperature signal or value exceeding the threshold.
